(19) United States
(12) Patent Application Publication
(10) Pub. No.: US 2009/0198764 A1
(43) Pub. Date: Aug. 6, 2009

(54) Task Generation from Monitoring System

(75) Inventors: Bernard Pham, Kirkland, WA (US); Israel Hilerio, Kenmore, WA (US); Olga Volgin, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/871,170

(22) Filed: Jan. 31, 2008

(51) Int. Cl. G06F 15/16

(52) U.S. Cl. 709/202

(57) ABSTRACT

A publication/subscription distribution mechanism receives alerts from an enterprise monitoring system, formats the alerts into a task capable of being managed by a task management application, categorizes the task into one or more subscription categories, and distributes the tasks to subscribers for the subscription categories. The distribution mechanism may automatically translate between an enterprise monitoring system and several different task management applications and may enable automated tracking of error conditions and their resolutions from detection to completion.

### BACKGROUND

Enterprise computing solutions often use a monitoring system for instrumenting and monitoring various computing devices connected to a network. Instrumentation may include monitoring clients that operate on a client device, collect data, and transfer the data to a central monitoring server, as well as agents that probe various services for responses and monitor various performance parameters. The monitoring systems often have the capability of determining when a device or service is not functioning correctly and creating an alert.

When enterprises become large, for example with 50, 500, or 5000 devices on a network, the volume of alerts can grow to unwieldy proportions. In a typical use, the alerts may be analyzed by a human operator and various tasks may be created and assigned to technicians for execution. For example, an alert may be generated when an email system unexpectedly halts. An alert may be viewed by a system administrator who may take on a task of fixing the system, or may dispatch a technician to correct the problem.

### SUMMARY

A publication/subscription distribution mechanism receives alerts from an enterprise monitoring system, creates a task based on the alert where the task is capable of being managed by a task management application, categorizes the task into one or more subscription categories, and distributes the tasks to subscribers for the subscription categories. The distribution mechanism may automatically translate between an enterprise monitoring system and several different task management applications and may enable automated tracking of error conditions and their resolutions from detection to completion.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a task generation system.

FIG. 2 is a flowchart illustration of an embodiment showing a method for generating alerts.

FIG. 3 is a flowchart illustration of an embodiment showing a method for task generation and publication.

FIG. 4 is a flowchart illustration of an embodiment showing a method for channel definition.

### DETAILED DESCRIPTION

A task generation and distribution system may automatically create tasks from a monitoring system. The tasks may include information that may help describe the symptoms detected by the monitoring system, along with other information that may help a technician further diagnose, correct, and verify the problem. In some cases, the tasks may be traceable so that audits may be performed on the problems and their resolution.

The tasks may be distributed using a subscription publication system. Various publication channels may be set up for specific types of conditions that may be monitored, for specific devices or services that are monitored, as well as for administrative or management purposes. Individual users may subscribe to one or more channels and may receive tasks through email or through a task management system.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

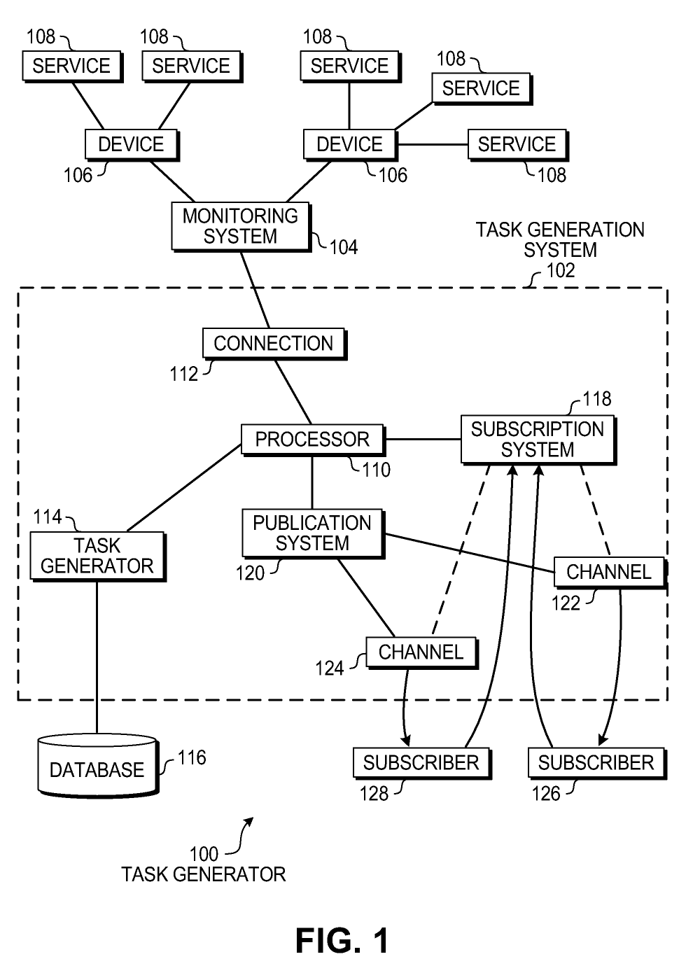

FIG. 1 is a diagram of an embodiment 100 showing a monitoring system with a task generator. Embodiment 100 may be incorporated in an administration system that is used to monitor and administer computer systems and servers. Embodiment 100 is an example of one architecture that may be used to monitor systems and services, detect an abnormality, create a task based on the abnormality, and distribute the task using a publication subscription system.

The diagram of FIG. 1 illustrates functional components of a system and may not correspond directly with a hardware or software component of a system. In some cases, a component may be a hardware component, a software component, or a combination of hardware and software. Hardware components may include general purpose components adaptable to perform many different tasks or specially designed components that may be optimized to perform a very specific function. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the various functions described.

The task generation system 102 may receive alerts from a monitoring system 104. The monitoring system 104 may be any type of system that collects performance and status data from various devices 106 and services 108 operating on the devices 106. In some embodiments, the monitoring system 104 may collect data that is provided from the devices 106 and services 108. In other embodiments, the monitoring system 104 may instrument the devices 106 and services 108 with a monitoring agent that may collect data and forward data to the monitoring system 104. In still other embodiments, the monitoring system 104 may periodically query the devices 106 and services 108 to determine status and performance data.

The monitoring system 104 may use a combination of various techniques to monitor hardware and software performance and status. The monitoring system 104 may monitor various devices 106 such as personal computers, servers, network devices such as routers, switches, hubs, firewalls, and wireless interface devices, peripheral devices such as scanners, printers, data storage systems, network appliances, mobile computing devices, telecommunications devices, security devices such as cameras and alarm systems, measuring instruments, or any other electronic device. In many cases, the monitoring system 104 may operate over a network connection to the various devices. Such a network may include hardwired or wireless portions.

The monitoring system 104 may monitor various services 108. The services 108 may include operating system services, applications, or other functions that are executed or operated on a specific device. Other services 108 may include services that interface with other devices, such as server services like messaging, network configuration, backup operations, network storage, and other services.

In some cases, the services 108 may be accessed through one device but may be hosted or executed on another device, which may be a remote device or system that is accessed through a network such as the Internet.

The monitoring system 104 may track any type of parameter with regard to the devices 106 or services 108. The monitoring system 104 may directly measure a parameter in some cases. In a simple example, the monitoring system 104 may track whether a nightly backup operation was successfully performed. In one embodiment of such an example, the backup system may be configured to send a status message at the end of operation indicating success or failure. In another embodiment, the monitoring system may periodically query a status file to determine success or failure. In still another embodiment, the monitoring system may install a monitoring agent on a device that hosts the backup system and the monitoring agent may detect the status of the backup system and transfer the status to the monitoring system.

The monitoring system 104 may infer status or performance conditions based on several data sources. For example, two, three, or more separate parameters may be checked to determine that a network connection is properly operational. The parameters may include a successful ping operation with a remote device over the connection with a latency measurement. Another parameter may include analysis of a log of communications to determine actual maximum data throughput. The two parameters may be used in conjunction with each other to determine the health of the network connection. In the example, the ping operation may ensure that domain name services (DNS) is properly functioning and that a basic connection is operational while the analysis of communication logs may help measure overall network performance in real world situations. In some cases, the DNS may not work for operations outside a local network while the communication inside a local network may still be functional.

The monitoring system 104 may create an alert based on predetermined conditions for various parameters. For example, an alert may be created when a specific parameter is outside a predetermined limit, or when a group of parameters creates a predefined condition. The alerts may indicate that a specific problem exists, that a service failed, a performance parameter is out of bounds, or some other indication. In many cases, the alert may not include a specific remedy.

The task generation system 102 may be an application or service that operates on a single server computer. In some embodiments, portions of the task generation system 102 may be performed by different server computers that may be connected by a network connection. In some such embodiments, one or more of the server computers may be located remotely and connected by the Internet or other wide area network.

The task generation system 102 has a processor 110 that may execute various software or hardware components that make up the task generation system 102.

The connection 112 may receive an alert from the monitoring system 104. In some embodiments, the connection 112 may be a network connection such as an Ethernet or wireless connection with a monitoring agent that may detect that an alert is incoming.

When an alert is received by the connection 112, a task generator 114 may create a task by referencing a database 116. The database 116 may contain detailed instructions that may be used by a technician for diagnosing, repairing, and validating specific error codes, alerts, or issues. In some embodiments, the alert itself may include corrective action that may be taken to address the issue. The task generator 114 may create a task with the various instructions included or links to web pages that may provide detailed instructions. In some instances, the task generator 114 may include software or a link to software or other verification mechanism that may be used to verify that a repair was successful.

The task generator 114 may convert an incoming alert into a useful task by adding detailed descriptions about the problem that generated the alert. For example, a task may include names or addresses of the affected devices and a host device for an affected service, specific users that may have been impacted or may have caused the issue, or any other detailed information that may assist a technician.

For example, the task generator 114 may receive an alert with an error code and a network address for an affected device. The task generator 114 may be able to look up the error code to determine a text description of the error, the physical location of the affected device, the primary user of the device, and other useful information that may be incorporated into the task.

The task generator 114 may also include administrative or audit information for each task. For example, information that may be useful for an Information Technologies manager may also be included. Such information may include a severity or priority designation, an estimated time for repair, a history of previous alerts that may be related to the same issue, device, user, or service, or other information.

In some embodiments, the task generator 114 may include a unique identifier for each task. The unique identifier may be a Globally Unique Identifier or GUID. The GUID may be used to track the flow of a task through a task management system as the task is assigned, transferred, escalated, worked on, completed, halted, incorporated into another task, or otherwise flows through a task management process.

The task may be created in a manner that it may operate within a specific task management system. Such systems may include various metadata or fields that are used to generate various reports, track progress, and otherwise manage many tasks across many technicians and, in some cases, across an entire enterprise.

The task may be distributed using a subscription system 118 and publication system 120. A set of channels 122 and 124 may be defined for various conditions, and various subscribers may subscribe to one or more channels. As shown in FIG. 1, subscriber 126 may subscribe to channel 122 while subscriber 128 may subscribe to both channels 122 and 124.

A channel may be defined for various uses. For example, channel may be defined for tasks relating to certain types of issues, such as email related tasks. Other channels may be defined for issues relating to a group of devices, such as the devices within a specific department or devices having a specific function such as network infrastructure. Each channel may be defined with a set of criteria for the tasks that may be published through the channel.

Some embodiments may permit a task to be published through a single channel, while other embodiments may enable a task to be published through two or more channels.

Multiple subscribers may subscribe to a channel. Even though a task may sometimes be executed by one individual, multiple people may be informed of the task. For example, a group of technicians may subscribe to a particular channel and each of the technicians may be capable of performing the task. A manager may allocate or assign the task to an individual technician before the task is actually performed.

In many cases, the subscribers may be human people who subscribe using an email system, a task tracking system, or some other application. In some cases, a subscriber may be a service, bot, or agent that serves as an interface to a task management system or other automated system.

The publication system 120 may receive a task from the task generator 114 and may publish the task on the various channels 122 and 124. In some embodiments, the publication system 120 may push tasks to subscribers. In a typical example of a push-type system, the publication system 120 may send the tasks as emails to a distribution list that includes each subscriber.

In other embodiments, the publication system 120 may have a pull-type system where the subscribers 126 and 128 may periodically check with the channels 122 and 124 to determine if a new task is available for download. If a task is available, the subscriber may download the task.

In some embodiments, the task itself may be made available through a website or other interface, but the notification or link to the task may be made through the publication system 120.

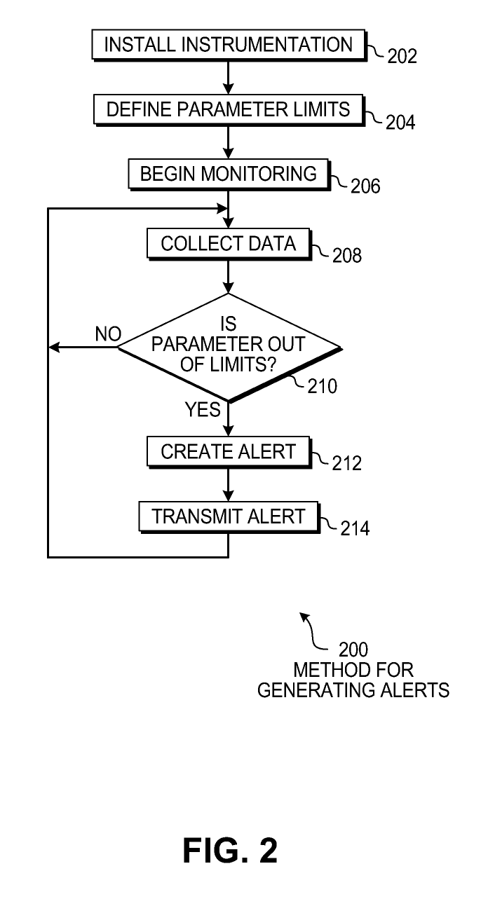

FIG. 2 is a flowchart illustration of an embodiment 200 showing a method for generating alerts. Embodiment 200 is a general method by which a monitoring system may monitor hardware and software components and generate and alert. Many other embodiments may use different sequences and techniques to generate alerts, which may include specialized hardware and software components to perform the functionality described in embodiment 200.

Instrumentation may be installed in block 202. Instrumentation may be any mechanism by which data may be collected. In some cases, software components may have an agent or other additional software that may be used to monitor specific parameters and communicate with a monitoring system. In other cases, a software agent may be installed and run to periodically check a parameter. In still other cases, a monitored service may have a feature that may be enabled to detect parameters and send messages to a monitoring system.

In some cases, instrumentation in block 202 may involve installing or configuring physical hardware to take data readings or monitor specific functions. For example, a network monitoring device may be attached to a network communications port to track network communications, measure network performance, or other functions. Such hardware may be able to generate logs of activities, perform various parameter calculations or measurements, and communicate with a monitoring system using various mechanisms.

Parameter limits may be defined in block 204. The parameter limits may define a normal or abnormal operating condition and set bounds or conditions for an alert to be generated. In some cases, a parameter limit may be a single value for a single parameter. An example may be a maximum value for a latency measurement for network communications between two devices on a local network. In other cases, a parameter limit may be a complex set of conditions that may involve several parameters.

In many cases, a parameter limit may be based on a static condition, such as disk storage exceeding 95% capacity. In other cases, a parameter limit may be a dynamic calculation, such as network traffic exceeding 200% of a moving average over a rolling two week period. Parameter limits may be defined in any manner with varying degrees of complexity.

Monitoring begins in block 206 and data is collected in block 208. If a parameter that is collected is not outside any limits in block 210, data collection continues in block 208.

If a parameter is out of limits in block 210, an alert may be created in block 212 and transmitted in block 214.

In some embodiments, an alert may be very detailed and may include many parameters that may be captured at the time the alert is created. In some cases, the parameters may be used for investigating the potential problem and may be defined by the type of alert. In other embodiments, an alert may be very simple and sometimes cryptic. Such alerts may or may not be in a useful, human readable form.

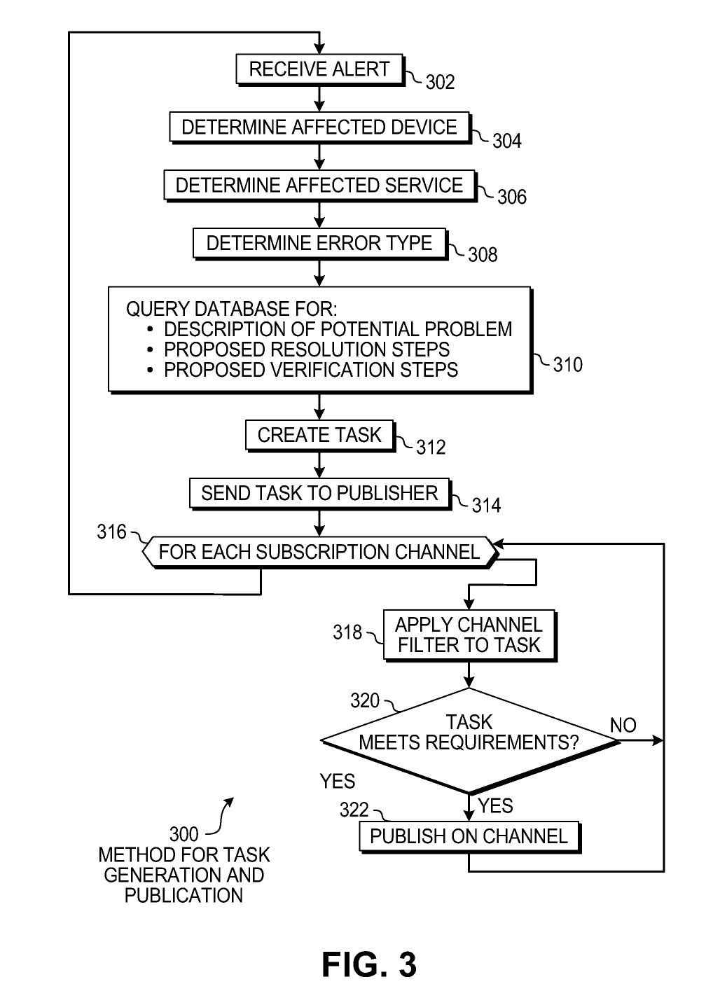

FIG. 3 is a flowchart illustration of an embodiment 300 showing a method for task generation and publication. Embodiment 300 is an example of a method by which a task may be created and published from a task. Embodiment 300 is a simplified example that has been chosen to illustrate the concepts of task generation. Other embodiments may use different techniques, sequences, architectures, or nomenclature to perform similar functions.

An alert may be received in block 302.

An affected device or set of devices is determined in block 304 from the alert definition. In some cases, an alert may provide a network address, subnet address, or some other definition of an affected device. In some embodiments, the alert definition may be supplemented by additional descriptors for an affected device. For example, a physical location for an affected device may be looked up from a database an included in a task description. Other parameters such as a primary owner of a device, a descriptive name for the device, or any additional information may be obtained.

In some embodiments, an alert may not specify an affected device. In some cases, a query may be made in block 304 to a monitoring system or to other devices to determine which devices have been affected by the alert.

Similarly, an affected service may be determined in block 306. In some cases, an affected service may be readily determined from an alert, while in other cases an affected service may be determined through a database that may contain services that may be affected by a particular type of alert. In some embodiments, a task generator may query particular services to determine if the services have or have not been affected.

The error type may be determined in block 308. The error type may be a more detailed description of a condition than is provided in an alert. In some cases, a detailed description may be obtained from a database of descriptions.

In block 310, a database may be queried for details that may be helpful for a technician who may respond to a task. Such details may include descriptions of a potential problem, proposed resolution steps or sequences, and proposed verification steps. In some cases, the details may be included in the body of a task or as web pages that may be linked from the task definition. In some embodiments, the alert received in block 302 may include suggested resolution steps or other information that may be used by a technician to address an issue raised by the alert.

The database may include any useful information that may be used by a technician to address the alert. In some cases, a history of previous alerts or tasks and their resolutions may be included.

Some alerts may include a mechanism for repairing a problem or for verifying that a problem has been properly addressed. Such mechanisms may be scripts, wizards, stand alone software applications, hardware test apparatus, or other mechanisms.

The task may be created in block 312 from the various data collected in blocks 304-310. In many cases, a task may be in email form and may contain an email body that includes many of the data in textual form. In some cases, a task may contain one or more links to web pages that may contain various instructions or other data.

In some cases, the task created in block 312 may be stored in a database that may be accessible through a web interface. The interface may present a task on a customized web page that contains task-specific information and links to additional information.

The task may be sent to the publisher in block 314. For each subscription channel in block 316, a channel filter may be applied in block 318 and, if the task meets the requirements for the channel in block 320, the task may be published on the channel in block 322. The filter of block 318 may be the conditions defined for each channel, as described previously.

Each embodiment may have a different mechanism for distributing tasks. In some embodiments, a task with accompanying descriptions, data, verification steps and other data may be distributed as an email. In some cases, such an email may include data as various attachments or as links to various websites. In some embodiments, a task notification may be distributed with a link to a website on which the details of a task may be obtained.

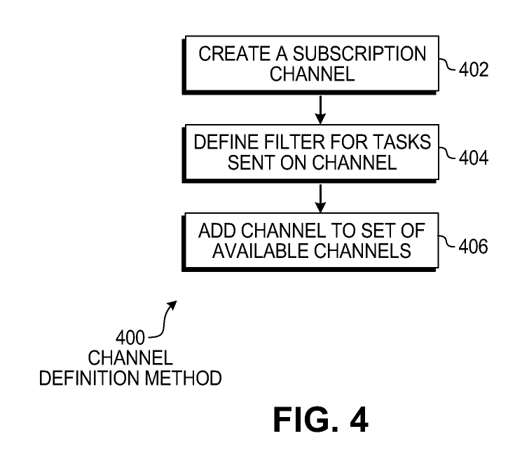

FIG. 4 is a flowchart illustration of an embodiment 400 showing a channel definition method. Embodiment 400 is a simple example of a method by which a distribution channel may be defined for tasks.

A subscription channel may be created in block 402. During the creation in block 402, a channel may be initiated in a distribution system. Typically, a channel may be named and various administrative settings may be configured in block 402. In some cases, restrictions on who may access a subscription channel may be defined.

Some such restrictions may permit one level of access to one type of subscriber and a different level of access to a different type of subscriber. For example, a technician that may be assigned the task may have access to procedural and instructional type data within the task but a manager may have administrative or managerial access and may be able to perform specific functions with an alert that a technician may not be able to perform.

A filter for tasks may be defined for the channel in block 404. The filter may define which tasks may be distributed through the channel. Such a definition may be quite complex in some situations. In some cases, a filter may be defined with a programming or scripting language with complex logic. In other cases, a filter may be defined by selecting between several parameters in a drop down list on a user interface. Each embodiment may have different techniques or mechanisms for defining a filter.

After the filter is defined, the channel may be added to a set of available channels in block 406. In some cases, channels may be advertised so that subscribers may browse available channels and select those channels in which they are interested. In other cases, a subscriber may be pre-subscribed to various types of channels or for specific channels and may not be able to view other channels or change subscriptions.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving an alert from a monitoring system adapted to monitor a plurality of devices and a plurality of services operating on said devices;
determining a first of said devices to which said alert applies;
determining a first of said services to which said alert applies;
determining a condition description based on said alert;
creating a task based on said alert, said task comprising a first reference to said first of said devices, a second reference to said first of said services, and said condition description;
determining a first subscription channel for said task;
publishing said task to said first subscription channel; and
transferring said task to a subscriber using said first subscription channel.

2. The method of claim 1, said task being incorporated in an email.

3. The method of claim 1, said task being adapted to be managed by a task management system, said task management system comprising an audit mechanism.

4. The method of claim 3, said audit mechanism using a GUID assigned to said task.

5. The method of claim 1 further comprising:
referencing a database to determine said condition.

6. The method of claim 1, said task further comprising at least one of a group composed of:
a set of proposed resolution steps;
a link to a set of proposed resolution steps;
a set of proposed verification steps; and
a link to a verification mechanism.

7. The method of claim 1 further comprising:
defining a plurality of subscription channels, each of said plurality of subscription channels having at least one filter.

8. The method of claim 1 further comprising:
receiving a subscription request;
determining at least one subscription channel for said request; and
storing said subscription request in a subscriber database.

9. The method of claim 8, said subscription request having an identifier, said identifier being at least one of a group composed of:
a user identifier;
an email identifier; and
a device identifier.

10. A computer readable medium comprising computer executable instructions adapted to perform the method of claim 1.

11. A system comprising:
a connection to a monitoring system adapted to monitor a plurality of devices and a plurality of services operating on said devices, said connection being adapted to receive alerts from said monitoring system;
a database comprising a plurality of condition descriptions for said alerts;
a task generator adapted to:
determine a first of said devices to which said alert applies;
determine a first of said services to which said alert applies;
determine a condition description based on said alert;
create a task based on said alert, said task comprising a first reference to said first of said devices, a second reference to said first of said services, and said condition description; and
a publication system adapted to:
determine a first subscription channel for said task;
publish said task to said first subscription channel; and
transfer said task to a subscriber using said first subscription channel.

12. The system of claim 11 further comprising:
a subscription management system adapted to:
receive a subscription request;
determine at least one subscription channel for said request; and
store said subscription request in a subscriber database.

13. The system of claim 12, said subscription request having an identifier, said identifier being at least one of a group composed of:
a user identifier;
an email identifier; and
a device identifier.

14. The system of claim 11, said database further comprising, for each of a plurality of alerts, at least one of a group composed of:
a set of proposed resolution steps;
a link to a set of proposed resolution steps;
a set of proposed verification steps; and
a link to a verification mechanism.

15. A method comprising:
monitoring a first device to determine at least one parameter;
determining that said parameter is outside a predetermined bounds;
creating an alert based on said parameter;
creating a task based on said parameter, said creating comprising:
determining a condition description based on said alert;
creating a task based on said alert, said task comprising a reference to said first device and said condition description; and
publishing said task by a method comprising:
determining a first subscription channel for said task;
publishing said task to said first subscription channel; and
transferring said task to a subscriber using said first subscription channel.

16. The method of claim 15 further comprising:
referencing a database to determine said condition.

17. The method of claim 16, said task further comprising at least one of a group composed of:
a set of proposed resolution steps;
a link to a set of proposed resolution steps;
a set of proposed verification steps; and
a link to a verification mechanism.

18. The method of claim 15 further comprising:
receiving a subscription request;
determining at least one subscription channel for said request; and
storing said subscription request in a subscriber database.

19. The method of claim 18, said subscription request having an identifier, said identifier being at least one of a group composed of:
a user identifier;
an email identifier; and
a device identifier.

20. A computer readable medium comprising computer executable instructions adapted to perform the method of claim 15.
